(19) United States
(12) Patent Application Publication
(10) Pub. No.: US 2026/0335958 A1
(43) Pub. Date: Oct. 29, 2026

(54) Method for Producing a Press-Hardened Shaped Sheet-Metal Part With a Press-in Element and Press-Hardened Shaped Sheet-Metal Part With a Press-in Element

(71) Applicant: Bayerische Motoren Werke Aktiengesellschaft, Muenchen (DE)

(72) Inventor: Michael Johannes MUELLER, Baar-Ebenhausen (DE)

(21) Appl. No.: 19/123,092

(22) PCT Filed: Oct. 13, 2023
(86) PCT No.: PCT/EP2023/078457

§ 371 Date: Apr. 22, 2025

(30) Foreign Application Priority Data
Nov. 2, 2022 (DE) 10 2022 128 974.5

(51) Int. Cl. B21D 21/00; B21C 37/02; B21J 5/06

(52) U.S. Cl. CPC B21D 21/00; B21C 37/02; B21J 5/06

(57) ABSTRACT

A method for producing a press-hardened shaped sheet-metal part includes the steps of heating a sheet-metal blank, imprinting at least one form-fit depression, and hot forming the sheet-metal blank. The method also includes the steps of making a hole in the shaped sheet-metal part and pressing the at least one press-in element into the hole. The at least one press-in element has a flange with at least one twisting-safeguard feature, which pushes into the imprinted form-fit depression.

### BACKGROUND AND SUMMARY

The disclosure relates to a method for producing a press-hardened shaped sheet-metal part which has at least one press-in element. The disclosure also relates to a press-hardened shaped sheet-metal part which has at least one press-in element and is produced by the method.

A press-in element along the lines of the disclosure is in particular a fastening element which is designed in the form of a press-in nut or press-in stud and is fastened on a sheet-metal component or part. At the fastening location, the sheet-metal part has a prefabricated hole (opening), into which the press-in element is pressed in a form-fitting and force-fitting manner. The press-in element has a flange, which is supported on the sheet-metal part. Twisting-safeguard features, for example twisting-safeguard lugs or twisting-safeguard ribs, can be provided on this flange and are pushed into the surface of the sheet-metal part when the press-in element is being pressed in. In respect of prior art, reference is made to DE 10 2011 108 224 A1 and DE 10 2019 133 891A1 .

In the case of a sheet-metal part formed from high-strength sheet-steel material, however, it is difficult for a reliable twisting safeguard to be formed by means of such twisting-safeguard features. This is because the sheet-metal material can be deformed with the aid of the press-in element or of the twisting-safeguard features only with difficulty, if at all, if the strength of the component is higher than that of the press-in element, which is typically the case for high-strength and super-high-strength components.

DE 10 2016 204 619 B4 describes a press-in connection between a high-strength component and a press-in element and also a method for forming such a press-in connection. The press-in element has been, or is, pressed into a prefabricated hole, wherein this hole has a non-circular cross-section for the purpose of forming a twisting safeguard.

Against this background, an object of the disclosure is to specify a method for producing a press-hardened shaped sheet-metal part which has at least one press-in element which is fastened so as to be safeguarded against twisting.

The object is achieved by the method according to the disclosure and by the alternative method according to the disclosure. An additional independent claim also extends the disclosure to a press-hardened shaped sheet-metal part which is produced by the method according to the disclosure. Further features of the disclosure can be gathered analogously, for all subjects of the disclosure, from the dependent claims, from the following description of the disclosure and from the figures, features described on an optional basis and by way of example also expressly being included.

In addition to the steps explained hereinbelow, the two methods according to the disclosure can have a preceding, as it were first step, namely:
supplying a sheet-metal blank made of press-hardening-compatible sheet-steel material (for example 22MnB5), wherein this can also be a tailored blank and/or wherein the sheet-metal blank can also have a corrosion-proof coating, in particular a zinc coating, and also supplying at least one press-in element, which has a flange provided with at least one twisting-safeguard feature.

The method according to the disclosure relates to so-called direct press hardening and comprises at least the following steps:
heating a sheet-metal blank, in particular to an austenitizing temperature, which can take place for example inductively or in a furnace;
imprinting at least one form-fit depression into the sheet-metal blank in the region of the press-in element to be fastened, wherein the imprinting operation takes place in the heated state of the sheet-metal blank or of the sheet-steel material;
hot forming the (heated) sheet-metal blank to give a shaped sheet-metal part and (more or less at the same time) press hardening the shaped sheet-metal part, which takes place in particular in a cooled press-hardening tool;
making a hole in the shaped sheet-metal part, the hole being provided for fastening the press-in element, wherein the hole is made in such a manner that the at least one (previously) imprinted form-fit depression is located alongside this hole;
pressing the press-in element into the hole, wherein the press-in element has a flange with at least one twisting-safeguard feature, which pushes into the imprinted form-fit depression (during the pressing-in operation), a twisting safeguard or twisting-prevention means being formed as a result.

The method according to the disclosure relates to so-called indirect press hardening and comprises at least the following steps:
forming a sheet-metal blank to give a shaped sheet-metal part, so-called preforming, wherein the forming or preforming takes place in particular in the cold state;
heating the shaped sheet-metal part, in particular to an austenitizing temperature, which can take place for example inductively or in a furnace;
imprinting at least one form-fit depression into the shaped sheet-metal part in the region of the press-in element to be fastened, wherein the imprinting operation takes place in the heated state of the shaped sheet-metal part or sheet-steel material;
press hardening the (heated) shaped sheet-metal part, which takes place in particular in a cooled press-hardening tool, wherein the shaped sheet-metal part is definitively shaped possibly for the first time when press hardening is taking place;
making a hole in the shaped sheet-metal part, the hole being provided for fastening the press-in element, wherein the hole is made in such a manner that the at least one (previously) imprinted form-fit depression is located alongside this hole;
pressing the press-in element into the hole, wherein the press-in element has a flange with at least one twisting-safeguard feature, which pushes into the imprinted form-fit depression (during the pressing-in operation), a twisting safeguard or twisting-prevention means being formed as a result.

The steps of a method according to the disclosure can also each be carried out in the aforementioned order so as to produce a press-hardened shaped sheet-metal part with a plurality of press-in elements, also different press-in elements, it also being possible for the press-in elements to be located on different sides of the sheet metal. Depending on the press-in element and/or the position thereof on the shaped sheet-metal part, the form-fit depressions and/or the holes can be of different designs. In addition, for the sake of simplicity, in some cases only the respective singular forms will be used hereinbelow in respect of the description and/or explanation of the disclosure, although this is not intended to represent any limitation.

A shaped sheet-metal part is a sheet-metal component or part which is shaped three-dimensionally in a forming process. In the case of so-called press hardening, rapid cooling causes the sheet-steel material to harden and/or increase in strength, preferably strengths of at least 1500 MPa being achieved. In the case of the disclosure, the three-dimensionally shaped sheet-steel material is press hardened at least in the region of the press-in element to be fastened. It is therefore possible for full press hardening or also just partial press hardening, or press hardening in certain regions, to be achieved. Provision can also be made for regions of different strengths to be produced during press hardening. In respect of press hardening, reference is also made to corresponding patent and specialist technical literature.

According to the disclosure, at least one so-called form-fit depression is imprinted into the sheet-steel material in the region of the press-in element to be fastened. The form-fit depression is imprinted into the surface of that side of the sheet metal which subsequently faces toward the flange of the press-in element and/or with which the flange of the press-in element comes into contact. A form-fit depression is understood to mean a depression which is formed locally in the surface of the steel material, extends only part of the way over the thickness of the sheet metal and is in particular not in evidence, or is invisible, on the other side, or opposite side, of the sheet metal. As seen in plan view, a form-fit depression can be of point-form or notch-like or groove-like design. A form-fit depression has a preferred imprinting depth of 0.1 mm to 0.3 mm, in particular approximately 0.2 mm. The sheet-steel material preferably has a sheet-metal thickness of 0.6 mm to 3.0 mm.

According to the disclosure, the form-fit depression is imprinted in the heated state of the sheet-steel material, preferably at a temperature of a few hundred degrees Celsius, in particular at a temperature of over 900 °C. Carrying out the imprinting operation in the heated state significantly reduces the imprinting force which is necessary. The disclosure makes use here of the fact that the sheet-steel material has to be heated in any case for the hot forming and/or press hardening. In particular, provision is made for the sheet-steel material, that is to say the sheet-metal blank or the preformed sheet-metal part, to be heated just once and, more or less just afterwards (without any notable drop in temperature), the form-fit imprint to be imprinted and the hot forming and/or press hardening carried out. Following the imprinting operation, the form-fit depression is also essentially maintained during the forming and/or press hardening of the sheet-steel material.

The form-fit depression can be imprinted prior to being hot formed and/or press hardened, that is to say prior to the sheet-steel material being positioned in the press-hardening tool, for example using a roll or stamping die, which is in particular heated. It is also possible, however, for the form-fit depression to be imprinted during the hot forming and/or press hardening or at the same time as the hot forming and/or press hardening, that is to say in the press-hardening tool, as long as the sheet-steel material has not yet been fully cooled or press hardened. For this purpose, the press-hardening tool can have an imprinting insert or the like.

The imprinted form-fit depression is then subsequently intended for a form-fitting connection to the twisting-safeguard feature on the flange of the press-in element. Following the press hardening, the strength of the sheet-steel material, at least in the region of the press-in element to be fastened, is typically higher than that of the press-in element. When the press-in element is being pressed in, the comparatively soft or less strong twisting-safeguard feature on the press-in element can deform on account of the surface pressure acting thereon (between the flange and the comparatively hard or strong sheet-metal surface) and, where there is overlapping with the form-fit depression, can deform into the form-fit depression. (This is more or less the reverse of the otherwise conventional procedure in which the comparatively hard or strong twisting-safeguard feature on the press-in element pushes into the comparatively soft or less strong sheet-steel material.) The form fit created results in the formation of a twisting safeguard or a twisting-prevention means, so that the press-in element is no longer able to twist relative to the shaped sheet-metal part. However, the press-in element is fastened on the shaped sheet-metal part in a different way, as will also be explained hereinbelow. In other words, the fastening and the twisting-prevention means are realized by different measures, pretty much as a result of functional separation.

Of course, the positions of the form-fit depression, which is imprinted first of all in the region of the press-in element to be fastened, and of the hole, which is made afterwards, are coordinated with one another. On the one hand, the hole is located where the press-in element is fastened. On the other hand, the form-fit depression is located alongside this hole, or alongside the edge of the hole, so that, when the press-in element is being pressed into the hole, the flange of the press-in element ends up coinciding with the form-fit depression. If the form-fit depression is imprinted into the sheet-steel material prior to the forming operation, its exact position can be established by way of a developed view of the geometry of the shaped sheet-metal part. Provision is preferably made so that, once the press-in element has been pressed into the hole, the flange of the press-in element fully covers the form-fit depression, in particular all the form-fit depressions (if a plurality of form-fit depressions are provided), so that they are no longer in evidence, or are invisible. In other words, once the press-in element has been pressed in (into the hole), the imprinted form-fit depression is fully concealed by the flange of the press-in element.

The imprinted form-fit depression can be of groove-like design and arranged around the hole, in particular in circular form. As an alternative, it is possible to provide a plurality of point-form and/or groove-like form-fit depressions which are arranged around the hole. It is thus possible to provide or imprint for example a plurality of in particular groove-like form-fit depressions, which are arranged (once the hole has been made) in a ray-like or star-like formation around the hole, it being possible to provide in particular at least three groove-like form-fit depressions which are spaced apart from one another at equal angular distances and extend approximately radially or helically away from the edge of the hole. Such, or similar, geometrically simple and easy-to-produce configurations of one or more form-fit depressions can ensure that, along with a suitable configuration of the (at least one) twisting-safeguard feature on the flange of the press-in element, the pressing-in operation ends up, even if no account is taken of a specific angle-of-rotation position, in overlapping being achieved (between at least one form-fit depression and at least one twisting-safeguard feature).

It is preferably the case that the press-hardening operation is followed by the hole provided for fastening the press-in element being made in the press-hardened shaped sheet-metal part, it being possible for this to be done by means of a die or punch, or preferably by means of a laser beam, once the press-hardened shaped sheet-metal part has been removed from the press-hardening tool. As an alternative, it is also possible for the hole to be made in the press-hardening tool, for which purpose the press-hardening tool can be provided with a die or punch or the like. Since no other forming operation is envisaged once the hole has been made, the position of the hole and the hole geometry created are maintained. It is also possible in principle, however, for the hole to be made prior to the forming and/or press-hardening operations, that is to say also following a preforming operation and prior to the subsequent heating and press-hardening operations, in particular also prior to the form-fit depression being imprinted, wherein an as yet upcoming change in the position of the hole and/or hole geometry may then possibly have to be taken into account. The hole preferably has a circular geometry or circular cross section, although it is also possible for a non-circular hole geometry to be provided.

As explained in the introduction, the press-in element is preferably a press-in nut (nut element) or a press-in stud (stud element), in particular with an M6, M8, M10 or M12 thread. However, the press-in element can also be a ball stud, a welding stud, a spacer or the like. The press-in element is preferably made from metal, in particular from steel. The press-in element has a flange, by means of which the press-in element is supported on the shaped sheet-metal part. The flange is designed in particular with an annular surface, which functions at the same time as a sheet-metal-contact surface. At least one twisting-safeguard feature, designed in particular in the form of an elevation, is arranged on the flange or on the sheet-metal-contact surface. The twisting-safeguard feature can be a twisting-safeguard lug or a twisting-safeguard rib, which extends in particular in the radial direction. It is preferable to provide a plurality of such twisting-safeguard features which are distributed circumferentially on the flange or on the sheet-metal-contact surface. However, the twisting-safeguard feature can also be a ring (i.e. at least one ring), which is formed in particular concentrically, or possibly also helically, around the threaded bore or the threaded pin. The different possible embodiments of twisting-safeguard features can also be combined with one another.

For fastening purposes, the press-in element preferably has an axial portion, which is intended to be pressed into the previously made hole in the shaped sheet-metal part, this resulting in a permanent form-fitting and force-fitting and/or frictionally fitting connection between the press-in element and the shaped sheet-metal part. The form-fitting and force-fitting connection can be realized by way of a bearing pressure and/or by way of a collar or the like, which is created during the pressing-in operation and engages around in particular the opposing side of the edge of the hole. The pressing-in operation can be done using a so-called setting device or other suitable tools, as described for example in DE 10 2021 100 983 A1 or DE 10 2021 203 153A1 .

The method according to the disclosure can be used, with a comparatively low level of outlay, to produce a press-hardened shaped sheet-metal part which has at least one press-in element. The twisting-prevention means created according to the disclosure surprisingly makes it possible for very high torques to be transmitted and/or absorbed. The disclosure is suitable in particular for series production. Furthermore, it is also readily possible to use sheet-metal materials with a corrosion-proof coating, for example a zinc coating.

A method according to the disclosure can advantageously be used for producing a vehicle-body component, in particular a frame side rail or cross rail, on which is preferably fastened a traction battery, in particular a high-voltage battery, for which the at least one press-in element is provided.

The disclosure will be explained in more detail hereinbelow in a non-limiting manner with reference to the figures. It is possible for the features described and/or shown in the figures, irrespective of specific combinations of features, to be general features of the disclosure, in which:

### BRIEF DESCRIPTION OF THE DRAWINGS

FIG. 1 depicts the course followed by the method according to the disclosure;

FIG. 2 depicts an alternative course followed by the method according to the disclosure; and

FIG. 3 shows a press-in element and a hole into which this press-in element is to be pressed and which has surrounding form-fit depressions in a press-hardened shaped sheet-metal part.

### DETAILED DESCRIPTION OF THE DRAWINGS

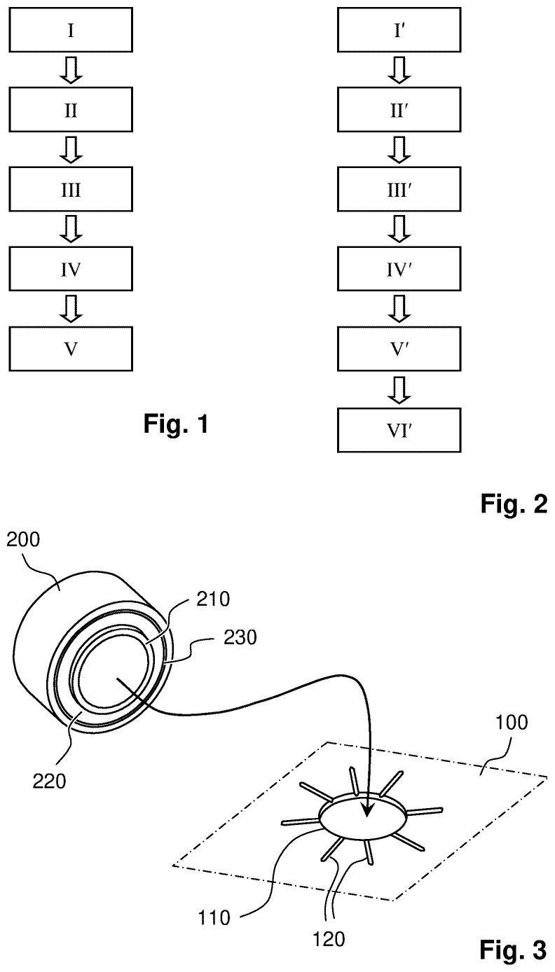

The method depicted in FIG. 1 for the purpose of producing a press-hardened shaped sheet-metal part which has at least one press-in element has the following steps:
(I) heating a sheet-metal blank;
(II) imprinting at least one form-fit depression;
(III) hot forming and press hardening the sheet-metal blank to give a press-hardened shaped sheet-metal part;
(IV) making a hole in the press-hardened shaped sheet-metal part (which can also be referred to as punching) in such a manner that the previously imprinted form-fit depression is located alongside the hole made;
(V) pressing the press-in element into the hole, wherein the press-in element has a flange with at least one twisting-safeguard feature, which pushes into the imprinted form-fit depression during the pressing-in operation.

The method depicted in FIG. 2 for the purpose of producing a press-hardened shaped sheet-metal part which has at least one press-in element has the following steps:
(I′) forming a sheet-metal blank to give a shaped sheet-metal part;
(II′) heating the shaped sheet-metal part;
(III′) imprinting at least one form-fit depression;
(IV′) press hardening the shaped sheet-metal part;
(V′) making a hole in the press-hardened shaped sheet-metal part (which can also be referred to as punching) in such a manner that the previously imprinted form-fit depression is located alongside the hole made;
(VI′) pressing the press-in element into the hole, wherein the press-in element has a flange with at least one twisting-safeguard feature, which pushes into the imprinted form-fit depression during the pressing-in operation.

The first method from FIG. 1 covers so-called direct press hardening and the second method from FIG. 2 covers so-called indirect press hardening. Further details relating to the individual method steps (I) to (V) and (I′) to (VI′), respectively, are described above. The method steps are preferably carried out chronologically in the cited sequence, it being possible for a specifically configured station to be provided for each method step. Workpiece transfer can take place in a suitable manner between the stations. Some method steps can also be combined or carried out simultaneously or in a different sequence, as likewise described above.

FIG. 3 shows the state prior to the press-in element being pressed in. The press-in element 200 is, by way of example, a press-in nut. The press-in element or the press-in nut has a flange 220, with a ring-design or annular twisting-safeguard feature 230, and also has an axial portion 210, which protrudes in relation to the flange 220. At the location intended for fastening the press-in element 200, the press-hardened shaped sheet-metal part 100 (illustrated only in detail form) has a hole 110 as well as a plurality of imprints or imprinted form-fit depressions 120, which are arranged in a ray-like or star-like formation around the hole 110.

The axial portion 210 of the press-in element 200 is intended to be pressed into the hole 110 in the shaped sheet-metal part 100, as depicted by the arrow. This gives rise to surface pressure between the flange 220 and the surface region surrounding the hole 110 in the shaped sheet-metal part 100, this surface pressure resulting in the annular twisting-safeguard feature 230 partially deforming into the form-fit depressions 120, namely wherever there is overlapping, a twisting safeguard or a twisting-prevention means being formed as a result.

Of course, it is also possible to provide an inverse design of the twisting-safeguard feature(s) and form-fit depression(s) such that the press-in element 200 has a plurality of radial twisting-safeguard ribs and the shaped sheet-metal part 100 has at least one imprinted annular form-fit depression. Further possible designs are described above.

### LIST OF REFERENCE SIGNS

I method step
II method step
III method step
IV method step
V method step
VI method step
100 shaped sheet-metal part
110 hole (opening)
120 form-fit depression
200 press-in element
210 axial portion
220 flange
230 twisting-safeguard feature

1.-9. (canceled)

10. A method for producing a press-hardened shaped sheet-metal part which has at least one press-in element, the method comprising the steps of:
heating a sheet-metal blank;
imprinting at least one form-fit depression in the region of the press-in element to be fastened;
hot forming the sheet-metal blank to give a shaped sheet-metal part and press hardening the shaped sheet-metal part;
making a hole in the shaped sheet-metal part in such a manner that the imprinted form-fit depression is located alongside the hole; and
pressing the at least one press-in element into the hole, wherein
the at least one press-in element has a flange with at least one twisting-safeguard feature, which pushes into the imprinted form-fit depression.

11. A method for producing a press-hardened shaped sheet-metal part which has at least one press-in element, the method comprising the steps of:
forming a sheet-metal blank to give a shaped sheet-metal part;
heating the shaped sheet-metal part;
imprinting at least one form-fit depression in the region of the press-in element to be fastened;
press hardening the shaped sheet-metal part;
making a hole in the shaped sheet-metal part in such a manner that the imprinted form-fit depression is located alongside the hole; and
pressing the press-in element into the hole, wherein
the press-in element has a flange with at least one twisting-safeguard feature, which pushes into the imprinted form-fit depression.

12. The method according to claim 10, wherein the operation of imprinting the form-fit depression takes place at the same time as the hot forming and/or press hardening.

13. The method according to claim 11, wherein the operation of imprinting the form-fit depression takes place at the same time as the hot forming and/or press hardening.

14. The method according to claim 10, wherein the form-fit depression has an imprinting depth of 0.1 mm to 0.3 mm.

15. The method according to claim 11, wherein the form-fit depression has an imprinting depth of 0.1 mm to 0.3 mm.

16. The method according to claim 10, wherein a plurality of form-fit depressions are imprinted and, once the hole has been made, are arranged in a star-like formation around the hole.

17. The method according to claim 11, wherein a plurality of form-fit depressions are imprinted and, once the hole has been made, are arranged in a star-like formation around the hole.

18. The method according to claim 10, wherein once the press-in element has been pressed in, the imprinted form-fit depression or the imprinted form-fit depressions is or are fully covered by the flange of the press-in element.

19. The method according to claim 11, wherein once the press-in element has been pressed in, the imprinted form-fit depression or the imprinted form-fit depressions is or are fully covered by the flange of the press-in element.

20. The method according to claim 10, wherein the sheet-metal blank has a corrosion-proof coating.

21. The method according to claim 11, wherein the sheet-metal blank has a corrosion-proof coating.

22. A press-hardened shaped sheet-metal part which has at least one press-in element and is produced by a method according to claim 10.

23. A press-hardened shaped sheet-metal part which has at least one press-in element and is produced by a method according to claim 11.

24. The press-hardened shaped sheet-metal part according to claim 22, which is designed in the form of a frame side rail or cross rail, of a vehicle body.

25. The press-hardened shaped sheet-metal part according to claim 23, which is designed in the form of a frame side rail or cross rail, of a vehicle body.
